(19) United States
(12) Patent Application Publication
(10) Pub. No.: US 2008/0191091 A1
(43) Pub. Date: Aug. 14, 2008

(54) METHOD AND DEVICE FOR RETRIEVING AIRCRAFT

(76) Inventors: Zachary Charles Hoisington, San Clemente, CA (US); Mark A. Page, Cypress, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/673,523

(22) Filed: Feb. 9, 2007

(51) Int. Cl. B64C 25/68; B64F 1/02

(52) U.S. Cl. 244/110 F

(57) ABSTRACT

An apparatus for retrieving an airborne object has a first hook having an inner area, wherein the first hook is connected to a forward end of the object. A biased member is connected to an open end of the first hook and is biased in a position that substantially closes off the inner area of the first hook. A second hook having an inner area is connected to the first hook. A biased member is connected to the open end of the second hook and is biased in a position that substantially closes off the inner area of the second hook. The first and second hooks are configured to receive one or more grid elements of a flexible grid through a retraction of the biased members when the airborne object is flown into the flexible grid.

### FIELD OF THE INVENTION

The invention broadly relates to a method and device for retrieving aircraft, and more particularly to a system and device for retrieving unmanned aircraft or drones.

### BACKGROUND OF THE INVENTION

Unmanned aerial vehicles, also known as UAVs, drones, and remotely piloted vehicles (RPVs), are aircraft capable of exhibiting controlled, sustained flight. Such unmanned aircraft are being increasingly used for applications that previously involved piloted aircraft because there is no risk of loss of life. However, with no human pilot on board, there are problems in landing and retrieving a UAV. It would be preferable therefore, to have the capability to retrieve the UAV while minimizing damage to it during the retrieval process.

### SUMMARY OF THE INVENTION

The present invention provides a method and apparatus for retrieving an airborne object such as an airplane. The apparatus has a first hook having an open end and an inner area, and is connected to a forward end of the object. A biased member is connected to the open end of the first hook and is biased in a position that substantially closes off the inner area of the first hook. A second hook has an open end and an inner area, and is connected to the first hook. A biased member is also connected to the open end of the second hook and is biased in a position that substantially closes off the inner area of the second hook. The first and second hooks are configured to receive one or more grid elements of a flexible grid through a retraction of the biased members when the airborne object is flown into the flexible grid. The first and second hooks have leading edges that may be spaced apart a distance equal to or greater than a dimension of a grid element. The flexible grid may be supported by and disposed within one side of a polyhedron shaped structure. According to some embodiments, the hooks and biased members may be positioned on the same side of the airborne object or on opposite sides of the airborne object.

According to the above embodiment, the apparatus may include a third open hook for ensnaring the grid, wherein the third hook is connected to a distal portion of the second hook. The first and second hooks may be connected to an upper side of the forward end of the object, and the apparatus may further include a lower first hook having an open end and an inner area. The lower first hook may be connected to an underside of the forward end of the object. A biased member is connected to the open end of the lower first hook and is biased in a position that substantially closes off the inner area of the lower first hook. A lower second hook has an open end and an inner area and is connected to the lower first hook. A biased member is connected to the open end of the lower second hook and biased in a position that substantially closes off the inner area of the lower second hook. The lower first and second hooks are configured to receive one or more grid elements of the flexible grid through a retraction of the biased members when the airborne object is flown into the flexible grid. The upper and lower hooks may be connected by a linking member.

In another embodiment, a method for retrieving an airborne object includes the step of placing a supporting a grid in a flight path of the object. The object has two hook and latch assemblies connected to an upper side of a leading tip of the object and two hook and latch assemblies connected to a lower side of the leading tip. In operation, the object is flown into the grid, whereby the momentum of the object carries the hook and latch assembly through the grid. As the hook and latch assembly penetrates the plane of the grid, the elements of the grid are captured in the hook and latch assemblies and the object is suspended from its leading tip.

In a further embodiment, an apparatus for retrieving an airborne object has first and second hook and latch assemblies connected together by a linking member. The hook and latch assemblies are substantially diametrically opposite one another with respect to the linking member. A third hook and latch assembly is connected to the first hook and latch assembly and a fourth hook and latch assembly connected to the second hook and latch assembly. An open hook is connected to a distal portion of either or both of the first or second hook and latch assemblies. The apparatus may be embodied in two outside layers and an inside layer, wherein the latch is located within the inside layer and is sandwiched between the two outside layers.

In another embodiment, the grid is supported by a structure having a base, a top having lesser dimensions that the base and linking members. The linking members connect corresponding corners of the base and top and define the sides of four side openings. The grid may be disposed within a side opening. An airborne object having a hook and latch assembly may be flown into the grid such that one or more grid elements of the grid are received into the hook and latch assembly, thereby capturing the object. The base, top and linking members may be inflatable.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein may illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

Features, aspects, and embodiments of the inventions are described in conjunction with the attached drawings, in which:

FIG. 1 is a perspective view of an apparatus in accordance with the principles of the present invention;

FIG. 2a is a side view of an embodiment of the apparatus of FIG. 1 on a nose of an airborne object, in accordance with the principles of the present invention;

FIGS. 2b and 2c are side sectional views of the apparatus of FIG. 1 in accordance with the principles of the present invention;

FIG. 3 is a side view of a preferred apparatus on a nose of an airborne object in accordance with the principles of the present invention.

FIG. 4 is a perspective view of the preferred apparatus of FIG. 3 in accordance with the principles of the present invention;

FIG. 5a is a perspective view of the preferred apparatus of FIG. 3 in accordance with the principles of the present invention;

FIG. 5b is a diagram illustrating the preferred apparatus in accordance with the principles of the present invention;

FIG. 6 is a perspective view of the preferred apparatus on a nose of an airborne object in accordance with the principles of the invention;

FIG. 7 is a perspective view of a structure for capturing the apparatus of the invention;

FIG. 8 is a perspective view of a structure including a grid and target for capturing the apparatus of the invention;

FIG. 9 is a perspective view of an airborne object being flown into the structure of FIG. 8 in order to capture the airborne object; and

FIGS. 10a-10c are front views of alternative configurations of the apparatus on the nose of an airborne object.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

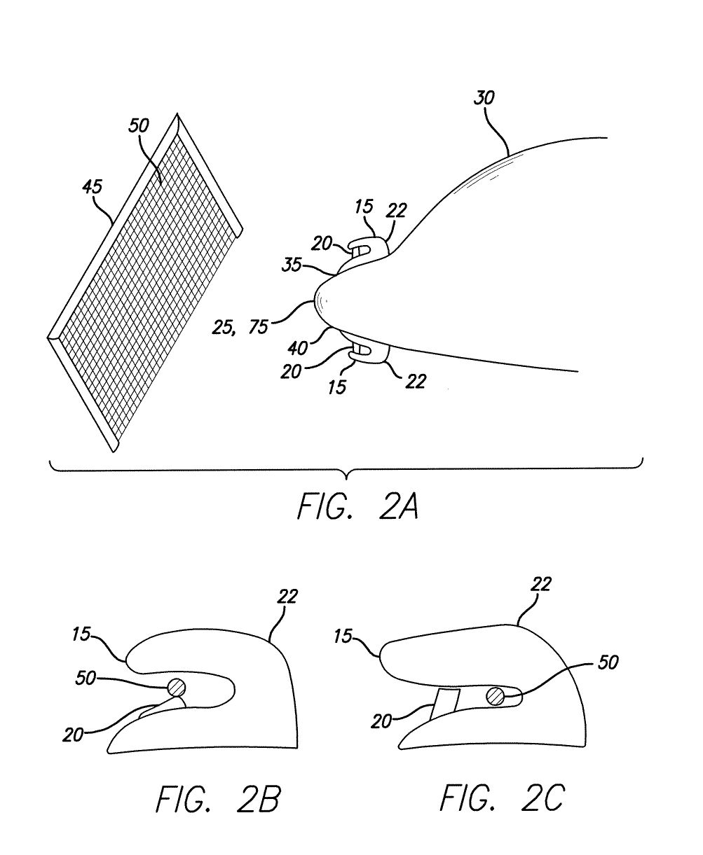

FIGS. 2a-2c illustrate a method and apparatus 10 in accordance with the principles of the invention. In particular, the apparatus 10 has two hook and latch assemblies 22 (including hooks 15 and latches 20) that are attached to a nose 25 of an aircraft 30. The hook and latch assemblies 22 are attached opposite one another with respect to the nose 25, with one attached to an upper side 35 of the nose 25 and the other attached to a lower side 40 of the nose 25. The latches 20 are biased to maintain the hooks 15 in a substantially closed orientation. At a specified location (such as on the ground, on a ship or any stationary or moving structure), a grid 45 can be placed to catch the aircraft 30. As the aircraft 30 is flown into the grid 45, elements 50 of the grid 45 are received into the hooks 15 by overcoming the tension of the latches 20. Once an element 50 is fully received in a hook 15, the latch 20 returns to its original position, thereby capturing the grid element 50 within the hook 15.

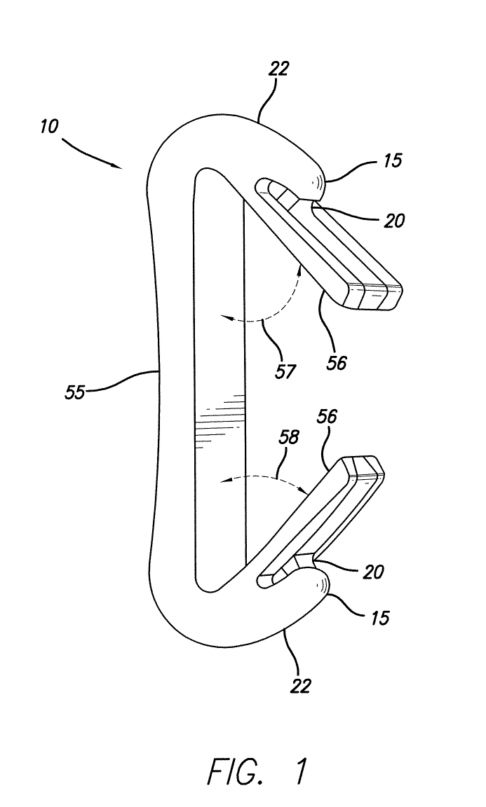

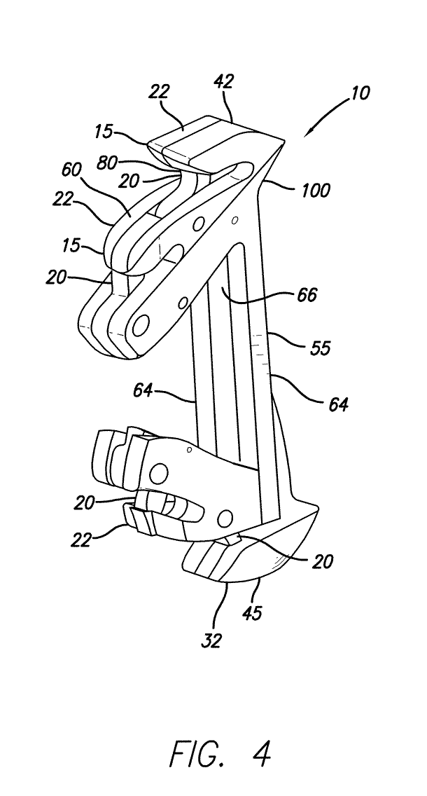

In a preferred implementation, as shown in FIGS. 1 and 4, the hook and latch assemblies 22 are connected by a linking member 55. A pair of assemblies 22 is connected by a cross member 56, which is connected to the linking member 55 at an angle 57, 58. The angles 57, 58 are determined by the contour of the object to which the apparatus 10 is attached, to allow the assemblies 22 to sit flush and generally tangent to the surfaces of the object. The apparatus 10 may be embodied in two outside layers 64 and an inside layer 66 wherein the latch is located within the inside layer 66 and is sandwiched between the two outside layers 64. In another embodiment, the assemblies 22 are formed as a single integral piece.

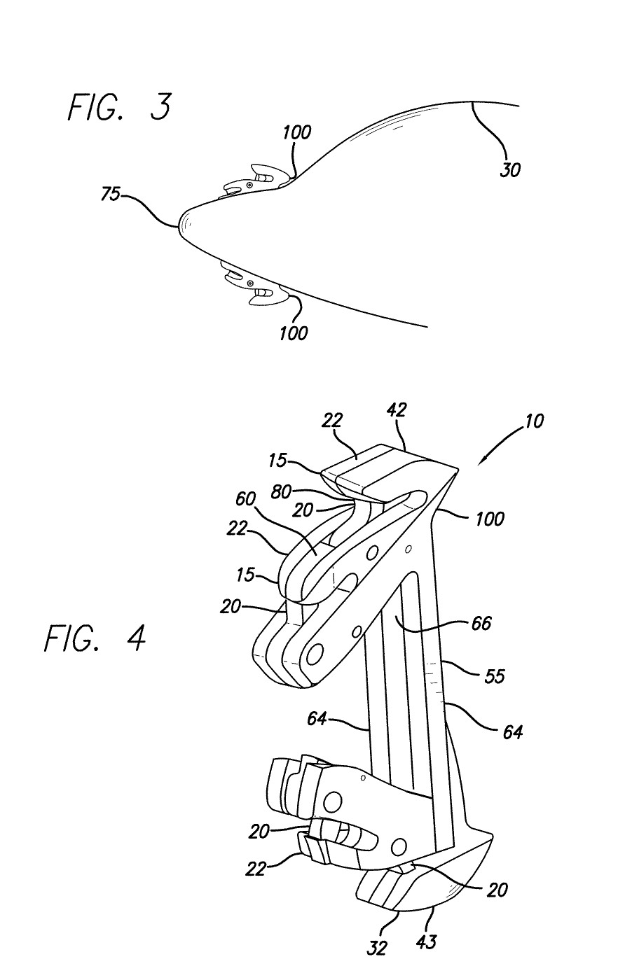

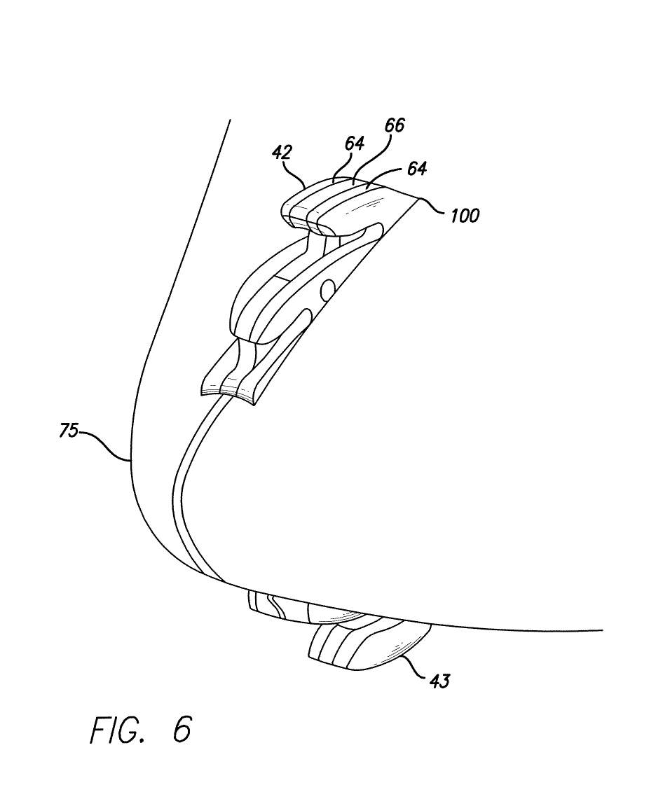

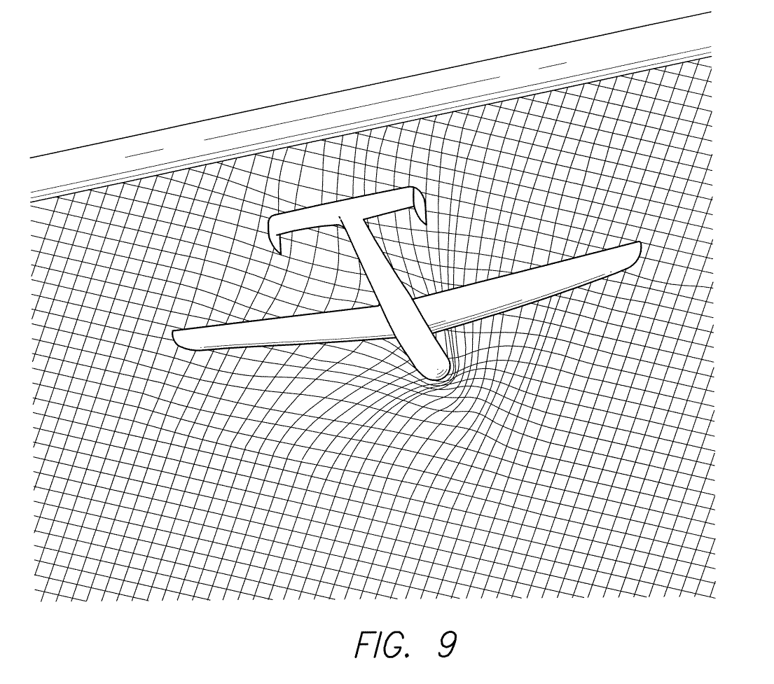

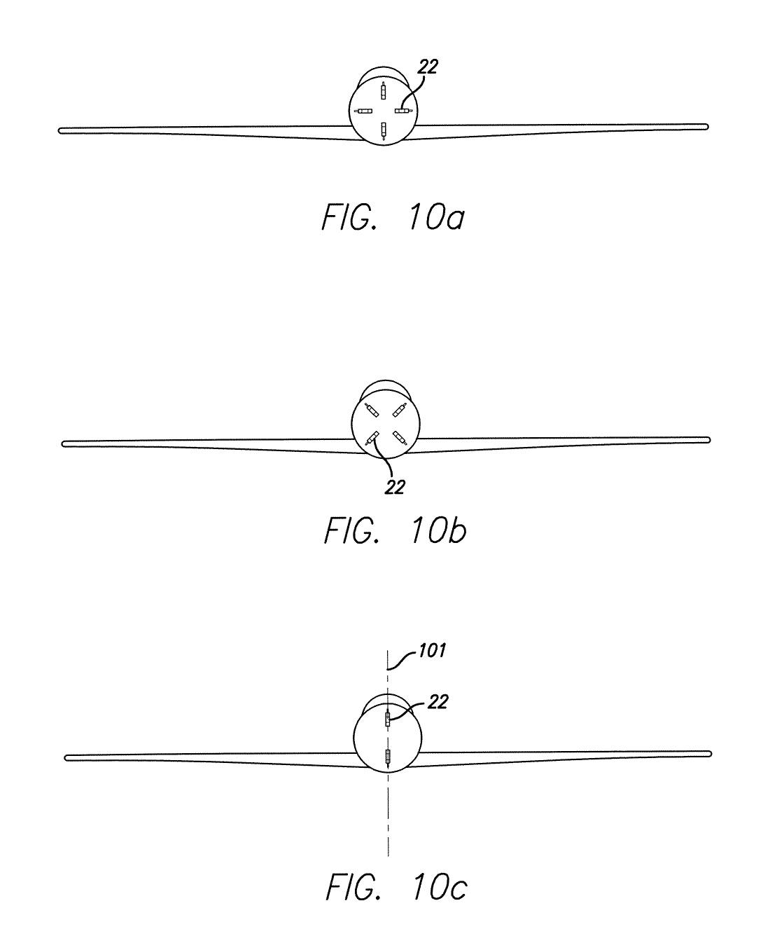

FIGS. 3-9 illustrate a preferred apparatus 10 and method for retrieving aircraft in accordance with the present invention. In particular, the apparatus 10 includes four hook and latch assemblies 22 that are grouped into pairs, with one assembly 22 attached behind another assembly 22. The assemblies 22 may be connected to a forward end or nose 75 of an object such as an aircraft, drone, or any similar flying device. Other embodiments may include multiple assemblies 22 positioned symmetrically on the port, starboard, top and bottom side of a flying object (see FIG. 10a) or positioned diagonally relative to the top and bottom (see FIG. 10b). Two pairs of the assemblies 22 may be connected together through linking member 55, with an upper pair of assemblies 42 and a lower pair of assemblies 43. Alternative embodiments may include two independent pairs of assemblies 22 that each connect separately to the object's frame, chassis or body.

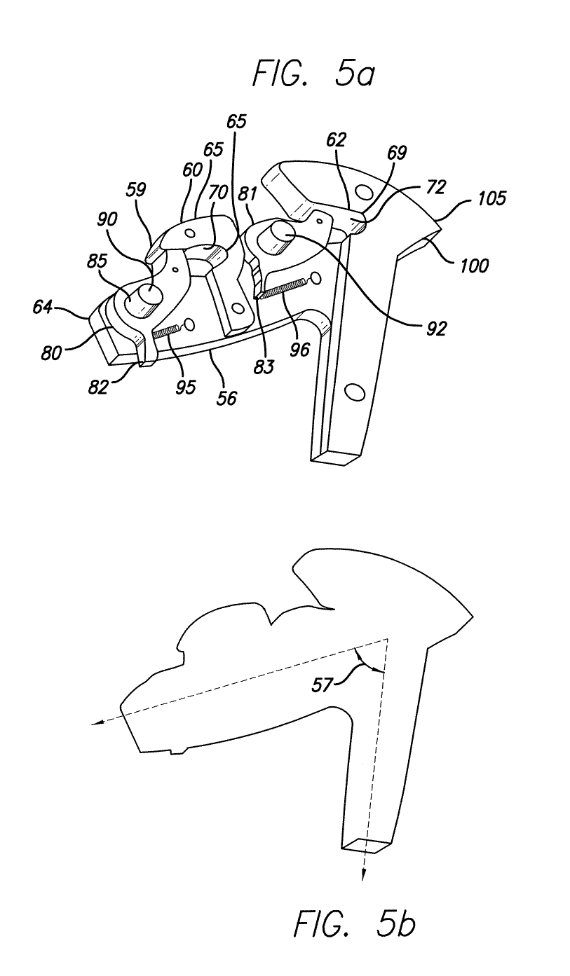

Referring to FIG. 5a, each assembly 22 includes a first hook 60 and second hook 62 connected to the cross member 56, having an open end 65, 67 and an inner area 70, 72. Biased latches 80, 81 having lever arms 82, 83 and a through hole 85, are rotatably attached to the cross member 56 via pins 90, 92. Biasing elements 95, 96 connect to lever arms 82, 83 and are anchored to the cross member 56 so that latches 80, 81 are biased in a closed orientation to substantially close off the inner areas 70, 72 of the hooks 60, 62. Biasing elements 95, 96 may comprise springs or any suitable elastic components. The rotatable latches 80, 81 may be rotated into the inner areas 70, 72 of the hooks 60, 62 (i.e., in an open orientation) when a hook is contacted by an object, such as a grid element 50. Each hook 60, 62 has a leading edge 59, and for a given pair of first 60 and second 62 hooks, the leading edges 59 are spaced apart by a predetermined distance. Referring to FIG. 2a, the predetermined distance may be based on the dimension 63 of the spacing of the grid elements 50 in grid 45, to optimize the likelihood that both hooks 60, 62 will capture grid elements 50. A third hook 100 is connected to a distal side 105 of the second hook 62 for catching a grid element 50 and to serve as a secondary option in the event an assembly 22 fails to engage a grid element 50. In one embodiment, as illustrated in FIG. 10c, all the assemblies 22 are positioned within a vertical plane 101 of the aircraft.

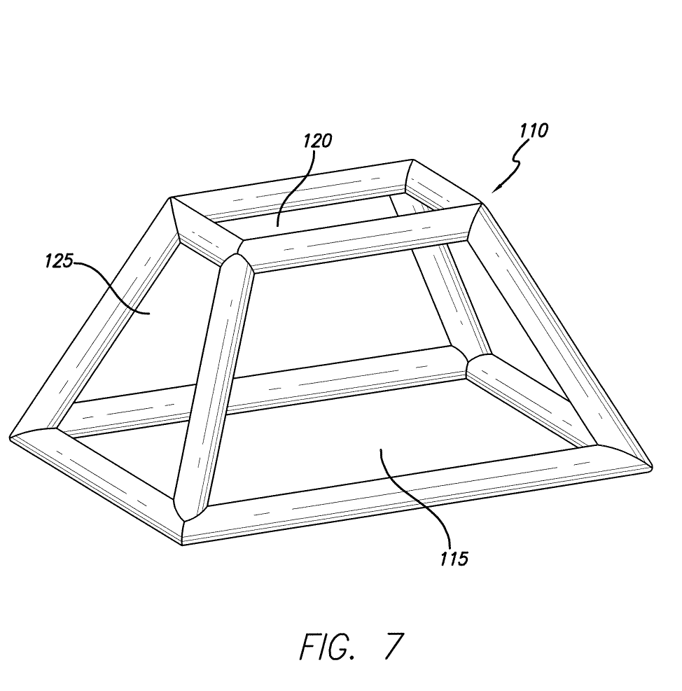

Referring to FIGS. 7-9, the grid 45 may be supported by a frame 110. In one embodiment, the frame 110 may take the shape of a six sided solid having a square bottom 115, a smaller square top 120 and trapezoidal sides 125. The frame 110 may be made of inflatable bladders 127, capable of inflation and deflation for ease of transportation and economic storage. Alternatively, the frame 110 may be made of rigid members such as wood, plastic or metal. The grid 50 may attach to the frame 110 on one of the sides 125 via connecting lines 130. The lines may attach to the grid 45 at its vertices 135 and to the frame 110 at the inside corners 140. The grid 45 may be made of nylon or any suitable elastic material. As would be appreciated by one skilled in the art, the frame 110 may take on numerous shapes and dimensions (e.g. rectangular solids, pyramids, etc.) without departing from the scope of the invention.

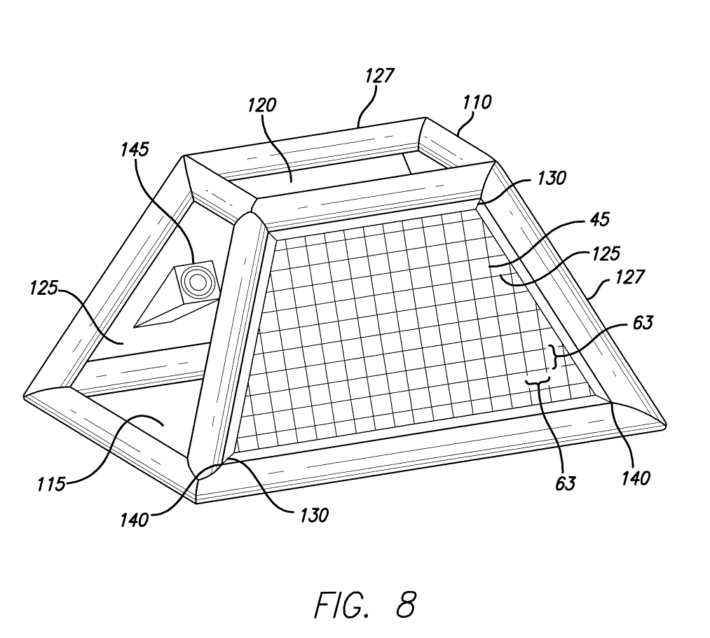

Referring to FIG. 8, in one embodiment, a visual target 145 may be placed behind the frame 110 to facilitate guidance of the aircraft into the grid 45. This may be particularly helpful if for example the aircraft is under manual remote control. In another embodiment, the frame may have a transponder 150 for guiding the aircraft with the aid of a global positioning system (GPS).

In operation, the frame 110 with grid 45 is placed at a location for retrieving an aircraft. A target 145 may be placed behind the grid 45 relative to the aircraft's line of sight with the grid. The aircraft is equipped with assembly 22 at its nose, which is guided into the grid 50, such that grid elements 50 are captured by the assemblies 22 and the aircraft becomes suspended by its nose.

Thus, it is seen that a method and apparatus for retrieving an airborne object is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

What is claimed is:

1. An apparatus for retrieving an airborne object, comprising:
a first hook having a inner area at an open end, the first hook connected to a forward end of the object;
a biased member placed at the open end of the hook and biased in a position that substantially closes off the inner area of the first hook;
a second hook having an inner area at an open end, the second hook connected to the first hook; and
a biased member placed at the open end of the second hook and biased in a position that substantially closes off the inner area of the second hook;
wherein the first and second hooks are configured to receive one or more grid elements of a flexible grid through a retraction of the biased members when the airborne object is flown into the flexible grid.

2. The apparatus of claim 1, further comprising a third hook comprising an open hook for ensnaring the grid.

3. The apparatus of claim 2, wherein the open hook is disposed in a substantially opposite orientation to, and is connected to, the second hook.

4. The apparatus of claim 1, herein the first and second hooks are spaced apart a distance equal to or greater than a dimension of a grid element.

5. The apparatus of claim 1, wherein the flexible grid is supported by and disposed within one side of an inflatable polyhedron shaped structure.

6. The apparatus of claim 1, wherein the first and second hooks are connected to an upper side of the forward end of the object, the apparatus further comprising:
a lower first hook having a inner area at an open, the lower first hook connected to a forward end of the object;
a biased member placed at the open end of the hook and biased in a position that substantially closes off the inner area of the lower first hook;
a lower second hook having an inner area at an open end, the lower second hook connected to the lower first hook; and
a biased member placed at the open end of the lower second hook and biased in a position that substantially closes off the inner area of the lower second hook;
wherein the first and second lower hooks are configured to receive one or more grid elements of a flexible grid through a retraction of the biased members when the airborne object is flown into the flexible grid.

7. The apparatus of claim 1, wherein the first and second hooks on the upper side of the airborne object are connected by a linking member to another set of first and second hooks on the lower side of the forward end of the airborne object.

8. The apparatus of claim 1 wherein all hooks are aligned with a vertical plane of the airborne object.

9. A method for retrieving an airborne object, comprising the steps of:
supporting a grid in a flight path of the object;
directing the object into the grid, the object having a hook and latch assembly connected to a forward end of the object, whereby a momentum of the object carries the hook and latch assembly into the grid;
capturing one or more grid elements of the grid in the hook and latch assembly; and
suspending the object from the grid by a forward end of the object.

10. The method of claim 9, wherein the object has one hook and latch assembly connected to an upper side of the forward end of the object and one hook and latch assembly connected to a lower side of the forward end of the object.

11. The method of claim 9, further comprising placing a target behind the grid with respect to the line of the flight of the object.

12. An apparatus for retrieving an airborne object, comprising:
first and second hook and latch assemblies connected together by a linking member,
wherein the hook and latch assemblies are diametrically opposite one another with respect to the linking member.

13. The apparatus of claim 12 wherein the hook and latch assemblies are aligned with a vertical plane of the object.

14. The apparatus of claim 12, further comprising a third hook and latch assembly connected to the first hook and latch assembly and a fourth hook and latch assembly connected to the second hook and latch assembly.

15. The apparatus of claim 12, further comprising an open hook connected to a either of the first or second hook and latch assembly and positioned in a substantially opposite orientation relative to the hook and latch assemblies.

16. The apparatus of claim 12, wherein the apparatus is comprised of two outside layers and an inside layer, and wherein the latch is located within the inside layer and is sandwiched between the two outside layers.

17. An apparatus for retrieving an airborne object, comprising:
a base;
a top;
linking members connecting corresponding corners of the base and top, the linking members defining the sides of four side openings; and
a grid disposed within a side opening;
wherein an airborne object having a hook and latch assembly is adapted to be flown into the grid such that one or more grid elements of the grid are received into the hook and latch assembly, thereby capturing the object.

18. The apparatus of claim 17, wherein the base, top and linking members are inflatable.

19. The apparatus of claim 17, wherein the top has lesser dimensions than the base.
